(19) United States
(12) Patent Application Publication
(10) Pub. No.: US 2006/0222787 A1
(43) Pub. Date: Oct. 5, 2006

(54) Recording medium

(75) Inventors: Joseph Hubertus Olijve, Kaatsheuvel (NL); Akira Kase, Tilburg (NL)

Correspondence Address: BANNER & WITCOFF, LTD., 28 STATE STREET, 28th FLOOR, BOSTON, MA, 02109-9601, US

(73) Assignee: Fuji Photo Film B.V., Tilburg (NL)

(21) Appl. No.: 11/396,955

(22) Filed: Apr. 3, 2006

Related U.S. Application Data
(63) Continuation of application No. PCT/NL04/00694, filed on Oct. 4, 2004.

(30) Foreign Application Priority Data
Oct. 3, 2003 (EP) EP 03078118.1

(51) Int. Cl. B41M 5/00

(52) U.S. Cl. 428/32.24

(57) ABSTRACT

The present invention relates to a recording medium, in particular an ink-jet recording medium of photographic quality that has excellent ink absorption speed, good drying characteristics and a good image printing quality. According to the present invention an ink-jet recording medium is provided, comprising a support to which at least an underlayer and an overlayer is supplied in which the overlayer contains at least one type of modified gelatin and the IEP of the overlayer is different from the IEP of the underlayer. The present invention is further directed to methods for obtaining and using such a medium.

### RELATED APPLICATIONS

This application is a continuation of PCT application no. PCT/NL/2004/000694, designating the United States and filed Oct. 4, 2004; which claims the benefit of the filing date of European application no. EP 03078188.1, filed Oct. 3, 2003; both of which are hereby incorporated herein by reference in their entirety.

### FIELD OF THE INVENTION

The present invention relates generally to a recording medium, in particular an ink-jet recording medium of photographic quality having a good image printing quality, in particular a good lightfastness, as well as to methods for preparing and using such media.

### BACKGROUND OF THE INVENTION

In a typical ink-jet recording or printing system, ink droplets are ejected from a nozzle at high speed towards a recording element or medium to produce an image on the medium. The ink droplets, or recording liquid, generally comprise a recording agent, such as a dye, and a relatively large amount of solvent in order to prevent clogging of the nozzle. The solvent, or carrier liquid, typically is based on water, and further comprises organic material such as monohydric alcohols and the like. An image recorded as liquid droplets requires a receptor on which the recording liquid dries quickly without running or spreading. High quality image reproduction using ink-jet printing techniques requires receptor substrates, typically sheets of paper or opaque or transparent film, that readily absorb ink droplets while preventing droplet diffusion or migration. Good absorption of ink encourages image drying while minimizing dye migration by which good sharpness of the recorded image is obtained.

US-A-2002/142141 discloses an image-receiving layer, which contains at least one water soluble polymer like polyvinyl alcohol, that swells when ink-jet ink is attached to the image-receiving layer. Improved performance with respect to durability, scuff resistance and image fidelity is said to be obtained.

DE-A-223 48 23 and U.S. Pat. No. 4,379,804 disclose methods in which gelatin is used in ink-receiving layers of ink-jet receiving sheets. From these documents, it has become clear that gelatin has an advantageous function for the absorption of ink solvents. The gelatin is said to improve smudge resistance, increase the definition quality, give high gloss, fast water absorbing properties, easy to achieve high water resistance and good dye fading resistance.

EP-A-0 742 109 describes the use of a combination of anionic and cationic fluorine containing surfactants in a gelatin containing ink receiving layer in order to improve dot reproduction and image quality including glossiness especially for graphic art applications.

EP-A-1 080 936 describes the use of a non-ionic surfactant giving a lower surface tension in the layer of an ink receptive multilayer farthest from the support and a second non ionic surfactant giving a higher surface tension in the layer nearer to the support material. Improved gloss and bleed is claimed.

A further important property of inkjet media is that they should provide for a good lightfastness, viz. the printed images must not fade over longer periods of time.

In order to improve the lightfastness of inkjet media, several approaches have been suggested in the prior art. JP-A-4 201 594, for instance, proposes to include hyperfine powder of transition metal oxides in the ink accepting layer and GB-A-2 147 003 suggests to combine metal salts with cationic polymeric substances to improve lightfastness of the produced images. Furthermore, JP-A-2002/220 559 and EP-A-0 869 010 describe a specific copolymer, which is to be included in one or more of the layers of the inkjet media, to improve lightfastness.

Although some improvement can be obtained by the described methods there remains a need for ink-jet material with good lightfastness. At the same time this inkjet material should provide for good image printing quality, good drying properties, improved curl and brittleness, having at the same time good behavior on bleed, beading and matte appearance at high density parts and also be available at low cost. It is towards fulfilling this need that the present invention is directed.

### SUMMARY OF THE INVENTION

The object of the present invention is to provide a recording medium having good overall properties, said recording medium more in particular being suited to produce images of photographic quality, wherein said medium has an improved lightfastness.

At the same time, it is desirable that the media of the present invention maintain other favorable properties with respect to brittleness at low humidities, curl behaviour, beading, matte appearance at high densities and bleeding properties.

It has been found that these objectives can be met by providing a recording medium in which at least two different gelatin based layers are applied, wherein the gelatins used have different values for their iso-electric-point (IEP). It has been found that such a gelatin based medium, which has a gradient in the IEP in the direction perpendicular to the substrate's surface, solves the above-mentioned problems.

### DETAILED DESCRIPTION

The invention is directed to a recording medium comprising a support and an ink-receiving layer adhered to said support, wherein the ink receiving layer is a multilayer comprising at least one overlayer and at least one underlayer, which underlayer is situated between said support and said overlayer, wherein said underlayer and said overlayer each comprise a gelatin or a modified gelatin, wherein the IEP of the gelatin or modified gelatin in the overlayer has a value that is different from the IEP value of the gelatin or modified gelatin in at least one of the underlayers.

The IEP is a well-known property of gelatins or modified gelatins, and may be defined as the pH at which the charge of the compound changes from positive to negative (at increasing pH values). The IEP may be assessed using known techniques, such as those described in PAGI (photographical gelatin industries of Japan) methods, 9^{th} edition, 2002, pp. 16/17.

Both the overlayer and the underlayer of this invention may be a multilayer of sublayers. The total number of sublayers is not particularly limited and depends largely on the available technique for application of layers and the required ink receiving properties of the ink receiving layer. The total number of sublayers may be from 2 to 25, more preferably from 3 to 17.

The present inventors have found that by providing an inkjet medium having a gradient in IEP for the gelatin (or modified gelatin) present in the layers of the medium, gives unexpected improved results with result to lightfastness of the medium. Light fastness is the dye stability during the display or storage at light condition. In order to evaluate this behaviour a sample is exposed for 144 hrs using a xenon light (85,000 lx) in an Atlas Wether-O-Meter C I 35A, manufactured by Atlas (Illinois, U.S.A.). The image density of the color on the printed area is measured before and after the xenon exposure and is measured by a reflection densitometer (X-Rite 310TR) and evaluated as the dye residual percentage. Without wishing to be bound by theory, it is assumed that the improvements obtained according to the present invention may be due to the fact that the pH of ink is usually lower than 7 (except for magenta ink, which usually has a pH that is between 7 and 8). The recording medium of the invention comprises at least one gelatin layer with a high IEP, between 6 and 11, below the overlayer comprising gelatin with an IEP between 4 and 6. At an overall pH of the ink receiving layer between 4 and 11, the layer comprising the gelatin with the high IEP may act as a mordant and thus fixes the dye. Since the IEP of the overlayer is different and preferably such that it remains negatively charged upon contact with ink, the ink will pass the overlayer without any difficulty. Consequently, once passed the overlayer, the dye will be captured in the underlayer and not diffuse from the underlayer to other layers, which results in better color density and improved lightfastness. Preferably the difference between the high IEP layer and the low IEP layer(s) is at least 1, more preferably at least 2.

According to a preferred embodiment, the IEP of the gelatin in the underlayer is from 6 to 11. The (modified) gelatin for the underlayer may be selected from various kinds of acid-treated gelatin, in particular from pig, cow skin/bone gelatin. The high IEP gelatin may also be obtained by chemical modification.

According to another embodiment the ink receiving layer is designed in such a way, that a gradient in the IEP is obtained. In all of these embodiments, the ink receiving layer is a multilayer comprising at least one overlayer comprising a gelatin with an IEP of preferably 4 to 6 and an underlayer, where the underlayer is a multilayer, in which in one embodiment the IEP of the layer nearest to the overlayer is higher than the IEP of the layer nearest to the substrate, which IEP is higher or comparable to the IEP of the overlayer, while in another embodiment, the IEP of the underlayer nearest to the overlayer is higher than the IEP of the overlayer but lower than the IEP of the layer nearest to the substrate.

Preferably the IEP of the overlayer in the medium of the present invention is from 4 to 6. The (modified) gelatin for the overlayer preferably is selected from gelatin compounds in which at least part of the NH₂ groups is chemically modified. A variety of modified gelatins can be used in the overlayer. Good results (i.e. in particular good gloss) are obtained, when at least 30% of the NH₂ groups of the gelatin is modified by a condensation reaction with a compound having at least one carboxylic group as described among others in DE-A-19721238. The compound having at least one carboxylic group can have an other functional group like a second carboxylic group and a long aliphatic tail, which in principle is not modified. Long tail in this context means from at least 5 to as much as 25 C atoms. This aliphatic chain can be modified still to adjust the properties like water solubility and ink receptivity. Preferred modified gelatins comprise an alkyl group (more preferably a C₅-C₂₅-alkyl group), a fatty acid group (more preferably C₅-C₂₅-fatty acid group), or both. Even more preferably the gelatins comprise a C₇-C₁₈-alkyl group, a C₇-C₁₈-fatty acid group, or both. Especially preferred gelatins of this type are succinic acid modified gelatins in which the succinic acid moiety contains an aliphatic chain from at least 5 to 25 carbon-atoms, where the chain can still be modified to a certain extend to adjust the water soluble properties or ink receptive properties. Most preferred is the use of dodecenylsuccinic acid modified gelatin, in which at least 30% of the NH₂ groups of the gelatin have been modified with said dodecenylsuccinic acid.

Another method for obtaining modified gelatin is described in EP-A-0576911, where said gelatin is formed from gelatin containing pendant amine groups and pendant carboxylic groups wherein at least one amine group of said gelatin is modified to form an amide of the formula —NHCOR. The process typically involves reaction of an amine group with an activated carboxyl, i.e. a reaction product of a carboxyl activating agent and carboxylic acid, i.e., RCOOH wherein R represents substituted or unsubstituted alkyl of 1-10 carbons, substituted or unsubstituted aryl of 6-14 carbons, or substituted or unsubstituted arylalkyl of 7-20 carbons.

Other suitable methods are described by V. N. Izmailova et al. (Colloid Journal, vol. 64, No. 5, 2002, pages 640-642), and by O. Toledano et al. (Journal of Colloid and Interface Science 200, pages 235-240) wherein hydrophobic groups are attached to gelatin molecules by reacting gelatin with respectively N-hydroxysuccinimide ester of caprylic acid and N-hydroxysuccinimide ester of various fatty acids (C₄-C₁₆).

Other modified gelatins giving good results are gelatins modified to have quaternary ammonium groups. An example of such a gelatin is the “Croquat™” gelatin produced by Croda Colloids Ltd. Still another modified gelatin known in the common gelatin technology, such as phtalated gelatin and acetylated gelatins are also suitable to be used in this invention.

The modified gelatin can be used alone or in combination with another water soluble polymer. Examples of these polymers include: fully hydrolysed or partially hydrolysed polyvinyl alcohol, hydroxyethyl cellulose, methyl cellulose, hydroxypropyl cellulose, polyvinylpyrolidone, any gelatin whether lime-processed or acid processed made from animal collagen, preferably gelatin made from pig skin, cow skin, pig bone or cow bone, polyethylene oxide, polyacrylamide, and the like. The modified gelatin is applied in the overlayer preferably in an amount ranging from 0.3 to 5 g/m² and most preferably from 0.5 to 3 g/m². A suitable amount of the water soluble polymer in the mixture is varying between 0 and 75 wt % of the amount of the modified gelatin. In case said water soluble polymer amount is higher than 75 wt %, the advantages of the modified gelatin may become less pronounced.

A further improvement of above mentioned properties can be obtained by including in the overlayer a fluorosurfactant in the amount between 2.5 mg/m² and 250 mg/m². It was found that this kind of surfactants improves amongst others the gloss and beading. Beading is defined as the phenomenon that large ink dots become visible on the printed image. The mechanism of “beading” is not clear yet. One hypothesis is that several small ink drops coalesce with each other on the surface of the inkjet media and form large ink droplets.

The term “fluorosurfactant” as used herein, refers to surfactants (viz. molecules having a hydrophilic and a hydrophobic part) that contain fluorocarbon or a combination of fluorocarbon and hydrocarbon as the hydrophobic part. Suitable fluorosurfactants may be anionic, non-ionic or cationic. Examples of suitable fluorosurfactants are: fluoro C₂-C₂₀ alkylcarboxylic acids and salts thereof, disodium N-perfluorooctanesulfonyl glutamate, sodium 3-(fluoro-C₆-C₁₁ alkyloxy)-1-C₃-C₄ alkyl sulfonates, sodium 3-(omega-fluoro-C₆-C₈ alkanoyl-N-ethylamino)-1-propane sulfonates, N-[3-(perfluorooctanesulfonamide)-propyl]-N,N-dimethyl-N-carboxymethylene ammonium betaine, perfluoro alkyl carboxylic acids (e.g. C₇-C₁₃ alkyl carboxylic acids) and salts thereof, perfluorooctane sulfonic acid diethanolamide, Li, K and Na perfluoro C₄-C₁₂ alkyl sulfonates, Li, K and Na N-perfluoro C₄-C₁₃ alkane sulfonyl —N-alkyl glycine, fluorosurfactants commercially available under the name Zonyl® (produced by E.I. Du Pont) that have the chemical structure of R_{f}CH₂CH₂SCH₂CH₂CO₂Li or R_{f}CH₂CH₂O(CH₂CH₂O)_{X}H wherein R_{f}=F(CF₂CF₂)₃₋₈ and x=0 to 25, N-propyl-N-(2-hydroxyethyl)perfluorooctane sulfonamide, 2-sulfo-1,4-bis(fluoroalkyl)butanedioate, 1,4-bis(fluoroalkyl)-2-[2-N,N,N-trialkylammonium)alkyl amino]butanedioate, perfluoro C₆-C₁₀ alkylsulfonamide propyl sulfonyl glycinates, bis-(N-perfluorooctylsulfonyl-N-ethanolaminoethyl)phosphonate, mono-perfluoro C₆-C₁₆ alkyl-ethyl phosphonates, and perfluoroalkylbetaine.

Also useful are the fluorocarbon surfactants described e.g. in U.S. Pat. No. 4,781,985 and in U.S. Pat. No. 5,084,340. Preferably the fluorosurfactant is chosen from Li, K and Na N-perfluoro C₄-C₁₃ alkane sulfonyl-N-alkyl glycine, 2-sulfo-1,4-bis(fluoroalkyl)butanedioate, 1,4-bis(fluoroalkyl)-2-[2-(N,N,N-trialkylammonium alkyl amino]butanedioate, perfluoroalkyl subsitituted carboxylic acids commercially available under the name Lodyne® (produced by Ciba Specialty Chemicals Corp.) and fluorosurfactants commercially available under the name Zonyl® (produced by E.I. Du Pont) that have the chemical structure of R_{f}CH₂CH₂SCH₂CH₂CO₂Li or R_{f}CH₂CH₂O(CH₂CH₂O)ₓH wherein R_{f}=F(CF₂CF₂)₃₋₈ and x=0 to 25.

Beside the modified gelatin or modified gelatin/water soluble polymer mixture and fluorosurfactant it may be desirable to add in the overlayer an anti-blocking agent to prevent image transfer when several printed inkjet mediums are piled up. Very suitable anti-blocking agents (also known as matting agents) have a particle size from 1 to 20 μm, preferably between 2 and 10 μm. The amount of matting agent is from 0.01 to 1 g/m², preferably from 0.02 to 0.5 g/m². The matting agent can be defined as particles of inorganic or organic materials capable of being dispersed in a hydrophilic organic colloid. The inorganic matting agents include oxides such as silicon oxide, titanium oxide, magnesium oxide and aluminium oxide, alkali earth metal salts such as barium sulphate, calcium carbonate, and magnesium sulphate, and glass particles. Besides these substances one may select inorganic matting agents which are disclosed in West German Patent No. 2,529,321, British Patent Nos. 760,775 and 1,260,772, U.S. Pat. Nos. 1,201,905, 2,192,241, 3,053,662, 3,062,649, 3,257,296, 3,322,555, 3,353,958, 3,370,951, 3,411,907, 3,437,484, 3,523,022, 3,615,554, 3,635,714, 3,769,020, 4,021,245 and 4,029,504. The organic matting agents include starch, cellulose esters such as cellulose acetate propionate, cellulose ethers such as ethyl cellulose, and synthetic resins. The synthetic resins are water insoluble or sparingly soluble polymers which include a polymer of an alkyl(meth)acrylate, an alkoxyalkyl(meth)acrylate, a glycidyl(meth)acrylate, a (meth)acrylamide, a vinyl ester such as vinyl acetate, acrylonitrile, an olefin such as ethylene, or styrene and a copolymer of the above described monomer with other monomers such as acrylic acid, methacrylic acid, alpha, beta-unsaturated dicarboxylic acid, hydroxyalkyl(meth)acrylate, sulfoalkyl(meth)acrylate and styrene sulfonic acid. Further, a benzoguanamin-formaldehyde resin, an epoxy resin, nylon, polycarbonates, phenol resins, polyvinyl carbazol or polyvinylidene chloride can be used. Besides the above are used organic matting agents which are disclosed in British Patent No. 1,055,713, U.S. Pat. Nos. 1,939,213, 2,221,873, 2,268,662, 2,322,037, 2,376,005, 2,391,181, 2,701,245, 2,992,101, 3,079,257, 3,262,782, 3,443,946, 3,516,832, 3,539,344,554, 3,591,379, 3,754,924 and 3,767,448, Japanese Patent O.P.I. Publication Nos. 49-106821/1974 and 57-14835/1982. These matting agents may be used alone or in combination.

The overlayer may optionally include thickener agents, biocides crosslinking agents and further various conventional additives such as colorants, colored pigments, pigment dispersants, mold lubricants, permeating agents, fixing agents for ink dyes, UV absorbers, anti-oxidants, light stabilising agents, dispersing agents, anti-foaming agents, leveling agents, fluidity improving agents, antiseptic agents, brightening agents, viscosity stabilizing and/or enhancing agents, pH adjusting agents, anti-mildew agents, anti-fungal agents, agents for moisture-proofing, agents for increasing the stiffness of wet paper, agents for increasing the stiffness of dry paper and anti-static agents.

The above-mentioned various additives can be added ordinarily in a range of 0 to 10 weight % based on the solid content of the ink receiving layer composition.

In another embodiment of this invention the beneficial effects of the modified gelatin and the fluorosurfactant is generated by applying these compounds in a separate overlayer coating, meaning, that also the overlayer is a multilayer. In this case it is preferable to have the fluorosurfactant in a coating layer farthest away from the substrate and the modified gelatin applied under this coating.

Also the underlayer can be a multilayer of sublayers.

When the underlayer is a multilayer, the layer closest to the overlayer will preferably comprise a gelatin with a high IEP and a hydrophilic polymer and optionally additives to adjust the physical properties. This swellable underlayer determines mainly the physical properties like water uptake, drying speed, brittleness and curl.

It was found that in case the underlayer is a multilayer it is beneficial to apply different concentrations of gelatin and water soluble polymer in the sublayers of the underlayer. A lower concentration of gelatin and water soluble polymer in the sublayer closest to the support enables a lower viscosity of the mixture which improves the coatability and allows higher coating speeds.

In a specific embodiment an adhesion promoting layer is applied between the support and the underlayer to enhance the adhesion of the coated layers onto the support. This adhesion promoting layer may be coated in a separate step or simultaneously with the receiving layers.

There is a variety of gelatins, both non-modified as well as modified gelatins which can be used in the underlayer. Examples of non-modified gelatins are alkali-treated gelatin (cattle bone or hide gelatin), acid-treated gelatin (pigskin, cattle/pig bone gelatin), or hydrolyzed gelatin. Examples of modified gelatins are acetylated gelatin, phthalated gelatin, quaternary ammonium modified gelatin, et cetera. These gelatins can be used singly or in combination for forming the underlayer.

Water soluble polymers suitable to be mixed with the (modified) gelatin include polyvinyl alcohol-(PVA-)based polymers, such as fully hydrolysed or partially hydrolysed polyvinyl alcohol (PVA), carboxylated polyvinyl alcohol, copolymers and terpolymers of PVA with other polymers, watersoluble cellulose derivatives such as hydroxyethyl cellulose, methyl cellulose, hydroxypropyl cellulose, carboxymethyl cellulose, casein, gum arabic, polyacrylic acid and its copolymers or terpolymers, polymethylacrylic acid and its copolymers or terpolymers, and any other polymers, which contain monomers of carboxylic acids such as acrylic acid, methacrylic acid, maleic acid and crotonic acid, polyvinylpyrolidone (PVP), polyethylene oxide, polyacrylamide, 2-Pyrrolidone and its derivatives such as N(2-hydroxyethyl)-2-pyrrolidone and N-cyclohexyl-2-pyrrolidone, urea and its derivatives such as imidazolidinyl urea, diazolidinyl urea, 2-hydroxyethylethylene urea, and ethylene urea.

Most of the water soluble polymers have very limited compatibility with gelatin. These polymers include fully hydrolyzed or partially hydrolyzed polyvinyl alcohol, hydroxyethyl cellulose, methyl cellulose, hydroxypropyl cellulose, polyethylene oxide, polyacrylamide, and the like. When a solution of gelatin in water is mixed with a solution in water of one of the above described polymers, micro or macro phase separation occurs in solution which persists in the dried coating. The dried coating exhibits high haze, low transparency, and low gloss. By applying the overcoating of the invention on such an underlayer, it will improve the appearance significantly. It is however better to use the inventive overcoating on an underlayer in which no phase separation between the gelatin and the water soluble polymer occurs. The system of a mixture of gelatin and a water soluble polymer is very well illustrated by means of a gelatin/PEO mixture as example. A homogeneous gelatin PEO mixture, i.e. a mixture where no phase separation occurs, may be obtained by adjusting the pH of the mixture. However there is no unique rule to determine the pH at which there is no phase separation. The best way is to follow the practical approach by making the required mixture of gelatin and water soluble polymer in water and adding alkali or acid until a homogeneous solution is obtained. The suitable pH range mainly depends on the gelatin type used and type of the water soluble polymer. It was found that (modified) acid treated gelatins having an iso-electric-point (IEP) of between 6.0 and 11 give a homogeneous solution with PEO at a pH below 5. At pH between 5 and 10, the mixture remains turbid, which indicate that the mixture is not homogeneous. At a pH higher than 11, a homogeneous solution can be obtained. For a lime treated gelatin, that has IEP value of between 4 and 6.0, a homogeneous mixture between gelatin and PEO can be obtained at a broader pH ranges, i.e. at a pH value lower than 4.5 or at a pH value higher than 6.0.

In addition to the above mentioned pH adjustment, we have now found, that it is not only important to have a homogeneous solution, but it is also beneficial to have a molecular weight of PEO of at least 100 000. A lower MW might also give satisfactory results, but in general most of the important properties, like curling, drying speed and brittleness improve when using a high MW PEO. In addition to this, it appeared to be beneficial to use an underlayer comprising various layers, in which the various layers have a different gelatin/PEO ratio. We have found that a low gelatin/PEO ratio in the layer adjacent to the overlayer and a higher gelatin/PEO ratio at the layers nearer to the support have a beneficial effect on properties like bleeding and beading. More specifically gelatin/PEO ratios (wt./wt.) in the layer nearest to the overlayer preferably vary between 1/1 to 8/1 and the gelatin/PEO ratios (wt./wt.) in the layers nearest to the support should vary between 1/1 and 12/1 with the condition, that the gelatin/PEO ratio of the layer adjacent to the overlayer is always lower, than the ratio of the other gelatin-PEO layers. When using more gelatin-PEO layers in the underlayer it is further beneficial to use a gradient for the gelatin/PEO ratio, meaning, that the gelatin/PEO ratio is lowest in the layer adjacent to the overlayer and said ratio is highest for the layer most near to the substrate.

The homogeneous gelatin-PEO solution of the underlayer, which is supplied to the substrate has a gelatin concentration between 5 and 20 wt. %.

The present invention is not to be limited to embodiments using PEO, since mixtures of gelatin and other water soluble polymers having a limited compatibility with each other may produce comparable results. It has been found by the present inventors that one may substitute the PEO with other water soluble polymers mentioned above such as PVP or PVA or a mixture between two or more water soluble polymers such as PEO and PVP. The ratio between the gelatin and said water soluble polymer(s) is preferably in the same ranges as described above for gelatin-PEO system.

Good results are obtained with PVA-based polymers. In general, a large variety of PVA-based polymers can be used, but the preferred PVA-based polymers are those which have been modified to give a good miscibility with aqueous gelatin solutions. These modifications are such, that in the PVA-based polymer back bone groups are introduced which provide a hydrogen bonding site, an ionic bonding site, carboxylic groups, sulphonyl groups, amide groups and the like, thus providing a modified PVA-based polymer. A modified PVA-based polymer giving very good results is a poly(vinyl alcohol)-co-poly(n-vinyl formamide) copolymer (PVA-NVF). Very suitable PVA-NVF copolymers for use with the present invention are the copolymers described in WO-A-03/054029, which have the general formula I:

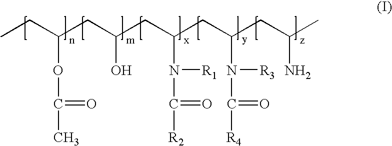

wherein

n is between 0 and about 20 mole percent;

m is between about 50 and about 97 mole percent;

x is between 0 and about 20 mole percent;

y is between 0 and about 20 mole percent;

z is between 0 and about 2 mole percent and

x+y is between about 3 and about 20 mole percent;

R₁, and R₃ are independently H, 3-propionic acid or C₁-C₆ alkyl ester thereof, or is 2-methyl-3-propionic acid or C₁-C₆ alkyl ester thereof; and

R₂ and R₄ are independently H or C₁-C₆ alkyl.

The water soluble polymer is preferably applied for the underlayer in an amount ranging from 0.5 to 15 g/m², more preferably from 1.0 to 8.0 g/m².

The homogeneous aqueous solution of the underlayer may further contain the following ingredients in order to improve the ink receiving layer properties with respect to ink receptivity and strength:
One or more plasticizers, such as ethylene glycol, diethylene glycol, propylene glycol, polyethylene glycol, glycerol monomethylether, glycerol monochlorohydrin, ethylene carbonate, propylene carbonate, tetrachlorophthalic anhydride, tetrabromophthalic anhydride, urea phosphate, triphenylphosphate, glycerolmonostearate, propylene glycol monostearate, tetramethylene sulfone, N-methyl-2-pyrrolidone, N-vinyl-2-pyrrolidone, and polymer lattices with low Tg-value such as polyethylacrylate, polymethylacrylate and the like.
One or more fillers; both organic and inorganic particles can be used as fillers. Useful filler examples are represented by silica (colloidal silica), alumina or alumina hydrate (aluminazol, colloidal alumina, a cat ion aluminum oxide or its hydrate and pseudo-boehmite), a surface-processed cat ion colloidal silica, aluminum silicate, magnesium silicate, magnesium carbonate, titanium dioxide, zinc oxide, calcium carbonate, kaolin, talc, clay, zinc carbonate, satin white, diatomaceous earth, synthetic amorphous silica, aluminum hydroxide, lithopone, zeolite, magnesium hydroxide and synthetic mica. Useful examples of organic fillers are represented by polystyrene, polymethacrylate, polymethyl-methacrylate, elastomers, ethylene-vinyl acetate copolymers, polyesters, polyester-copolymers, polyacrylates, polyvinylethers, polyamides, polyolefins, polysilicones, guanamine resins, polytetrafluoroethylene, elastomeric styrene-butadiene rubber (SBR), urea resins, urea-formalin resins. Such organic and inorganic fillers may be used alone or in combination.
One or more mordants. Mordants may be incorporated in the ink-receptive layer of the present invention. Such mordants are represented by cationic compounds, monomeric or polymeric, capable of complexing with the dyes used in the ink compositions. Useful examples of such mordants include quaternary ammonium block copolymers. Other suitable mordants comprise diamino alkanes, ammonium quaternary salts and quaternary acrylic copolymer latexes. Other suitable mordants are fluoro compounds, such as tetra ammonium fluoride hydrate, 2,2,2-trifluoroethylamine hydrochloride, 1-(alpha, alpha, alpha-trifluoro-m-tolyl)piperazine hydrochloride, 4-bromo-alpha, alpha, alpha-trifluoro-o-toluidine hydrochloride, difluorophenylhydrazine hydrochloride, 4-fluorobenzylamine hydrochloride, 4-fluoro-alpha, alpha-dimethylphenethylamine hydrochloride, 2-fluoroethylaminehydrochloride, 2-fluoro-1-methylpyridinium-toluene sulfonate, 4-fluorophenethylamine hydrochloride, fluorophenylhydrazine hydrochloride, 1-(2-fluorophenyl)piperazine monohydrochloride, 1-fluoro pyridinium trifluoromethane sulfonate.
One or more conventional additives, such as:
   pigments: white pigments such as titanium oxide, zinc oxide, talc, calcium carbonate and the like; blue pigments or dyes such as cobalt blue, ultramarine or phthalocyanine blue; magenta pigments or dyes such as cobalt violet, fast violet or manganese violet;
   biocides;
   pH controllers;
   preservatives;
   viscosity modifiers;
   dispersing agents;
   UV absorbing agents;
   brightening agents;
   anti-oxidants;
   light stabilizing agents
   antistatic agents; and/or
   anionic, cationic, non-ionic, and/or amphoteric surfactants, typically used in amounts ranging from 0.1 to 1000 mg/m², preferably from 0.5 to 100 mg/m².

These additives may be selected from known compounds and materials in accordance with the objects to be achieved.

The above-mentioned additives (plasticizers, fillers/pigments, mordants, conventional additives) may be added in a range of 0 to 30% by weight, based on the solid content of the water soluble polymers and/or gelatin in the underlayer.

The particle sizes of the non water-soluble particulate additives should not be too high, since otherwise a negative influence on the resulting surface will be obtained. The used particle size should therefore preferably be less than 10 μm, more preferably 7 μm or less. The particle size is preferably above 0.1 μm, more preferably about 1 μm or more for handling purposes.

The gelatin is preferably used in a total amount of from 1 to 30 g/m², and more preferably from 2 to 20 g/m². The amount of hydrophilic polymer used in a certain formulation can be easily calculated from the indicated amount of gelatin and is typically in the range from 100 mg/m² to 30 g/m² and more preferably between 200 mg/m² and 20 g/m². When preparing the ink-jet-receiving sheet by coating a plurality of layers, each layer comprises an amount of gelatin ranging from 0.5 to 10 g/m².

If desired, the gelatin can be cross-linked in the image-recording elements of the present invention in order to impart mechanical strength to the layer. This can be done by any cross-linking agent known in the art.

For gelatin, there is a large number of known cross-linking agents—also known as hardening agents. Examples of the hardener include aldehyde compounds such as formaldehyde and glutaraldehyde, ketone compounds such as diacetyl and chloropentanedion, bis(2-chloroethylurea), 2-hydroxy-4,6-dichloro-1,3,5-triazine, reactive halogen-containing compounds disclosed in U.S. Pat. No. 3,288,775, carbamoyl pyridinium compounds in which the pyridine ring carries a sulphate or an alkyl sulphate group disclosed in U.S. Pat. No. 4,063,952 and U.S. Pat. No. 5,529,892, divinylsulfones, and the like. These hardeners can be used singly or in combination. The amount of hardener used, preferably ranges from 0.1 to 10 g, and more preferably from 0.1 to 7 g based on 100 g of gelatin contained in the ink-receiving layer. For PVA, for example, it is preferable to choose a cross-linking agent selected from borax, glyoxal, dicarboxylic acids and the like.

The process for producing an ink-jet recording medium comprises the steps of preparation of one or more homogeneous aqueous mixtures for one or more underlayer(s) wherein at least one mixture comprises a gelatin or a modified gelatin, and preparation of at least one aqueous mixture for the overlayer comprising at least a (modified) gelatin with an IEP different from the IEP of the gelatin in (one of) the underlayers. The resulting formulations for the overlayer(s) and underlayer or underlayers can be coated consecutively or simultaneously to a support by any method known in the art. The coating methods are for example, a curtain coating, an extrusion coating, an air-knife coating, a slide coating, a roll coating method, reverse roll coating, dip coating processes and a rod bar coating.

The support used in this invention may suitably be selected from a paper, a photographic base paper, a paper coated on both sides with a polymer layer, pigment coated paper, a synthetic paper or a plastic film in which the top and back coatings are balanced in order to minimise the curl behaviour. The backside coating comprises gelatin or a water soluble polymer in an amount ranging preferably from 1 to 20 g/m², more preferably from 4 to 15 g/m². The optimum amount of the backside coating depends on the type of gelatin, the type of water soluble polymer and on the composition of the layers at the ink receiving side of the medium and is determined experimentally. The preferred polymer for the backside coating is gelatin.

An important characteristic of the inkjet recording medium is the gloss. It has been found that the gloss of the medium can be improved by selecting the appropriate surface roughness of the used support. It was found, that providing a support having a surface roughness characterised by the value Ra being less than 1.0 μm, preferably below 0.8 μm a very glossy medium can be obtained. A low value of the Ra indicates a smooth surface. The Ra is measured according to DIN 4776; software package version 1.62 with the following settings:

(1) Point density 500 P/mm (2) Area 5.6×4.0 mm² (3) Cut-off wavelength 0.80 mm (4) Speed 0.5 mm/sec., using a UBM equipment.

The base paper to be used as the support for the present invention is selected from materials conventionally used in high quality printing paper. Generally it is based on natural wood pulp and if desired, a filler such as talc, calcium carbonate, TiO₂, BaSO₄, and the like can be added. Generally the paper also contains internal sizing agents, such as alkyl ketene dimer, higher fatty acids, paraffin wax, alkenylsuccinic acid, epichlorhydrin fatty acid amid and the like. Further the paper may contain wet and dry strength agents such as a polyamine, a poly-amide, polyacrylamide, poly-epichlorhydrin or starch and the like. Further additives in the paper can be fixing agents, such as aluminium sulphate, starch, cationic polymers and the like. The Ra value for a normal grade base paper is well above 1.0 μm typically above 1.3 μm. In order to obtain a base paper with a Ra value below 1.0 μm such a normal grade base paper can be coated with a pigment. Any pigment can be used. Examples of pigments are calcium-carbonate, TiO₂, BaSO₄, clay, such as kaolin, styrene-acrylic copolymer, Mg—Al-silicate, and the like or combinations thereof. The amount being between 0.5 and 35.0 g/m² more preferably between 0.5 and 20.0 g/m². This pigmented coating can be applied as a pigment slurry in water together with a suitable binders like styrene-butadiene latex, methyl methacrylate-butadiene latex, polyvinyl alcohol, modified starch, polyacrylate latex or combinations thereof, by any technique known in the art, like dip coating, roll coating, blade coating or bar coating. The pigment coated base paper may optionally be calendered. The surface roughness can be influenced by the kind of pigment used and by a combination of pigment and calendering. The base pigment coated paper substrate has preferably a surface roughness between 0.4 and 0.8 μm. If the surface roughness is further reduced by super calendaring to values below 0.4 μm the thickness and stiffness values will generally become below an acceptable level.

The ink receiving multilayer of the present invention can be directly applied to the pigment coated base paper. In another embodiment, the pigment coated base paper having a pigmented top side and a back-side is provided on both sides with a polymer resin through high temperature co-extrusion giving a laminated pigment coated base paper. Typically temperatures in this (co-)extrusion are above 280° C. but below 350° C. The preferred polymers used are poly olefins, particularly polyethylene. In a preferred embodiment the polymer resin of the top side comprises compounds such as an opacifying white pigment e.g. TiO₂ (anatase or rutile), ZnO or ZnS, dyes, coloured pigments, including blueing agents, like e.g. ultramarine or cobalt blue, adhesion promoters, optical brighteners, antioxidant and the like to improve the whiteness of the laminated pigment coated base paper. By using other than white pigments a variety of colors of the laminated pigment coated base paper can be obtained. The total weight of the laminated pigment coated base paper is preferably between 80 and 350 g/m 2. The laminated pigment coated base paper shows a very good smoothness, which after applying the ink receiving layer of the present invention results in a recording medium with excellent gloss.

Examples of the material of the plastic film are polyolefins such as polyethylene and polypropylene, vinyl copolymers such as polyvinyl acetate, polyvinyl chloride and polystyrene, polyamide such as 6,6-nylon and 6-nylon, polyesters such as polyethylene terephthalate, polyethylene-2 and 6-naphthalate and polycarbonate, and cellulose acetates such as cellulose triacetate and cellulose diacetate. The support may be subjected to a corona treatment in order to improve the adhesion between the support and the ink receiving layer. Also other techniques, like plasma treatment can be used to improve the adhesion.

The swellable ink-receiving layer has a dry thickness from 1 to 50 micrometers, preferably from 5 to 25 and more preferably between 8 and 20 micrometers. If the thickness of said ink receiving layer is less than 1 micrometer, adequate absorption of the solvent will not be obtained. If, on the other hand, the thickness of said ink receiving layer exceeds 50 micrometers, no further increase in solvent absorptivity will be gained.

The recording medium of this invention can be used in any printing application, where a photographic quality print is required. Although the invention is described herein with particular reference to inkjet printing, it will be apparent to the skilled person that the high quality recording media of the present invention are not limited to inkjet recording media (viz. media suitable to be printed on using inkjet printers), but that it is within the scope of the present invention to provide recording media that are suitable for creating high quality images by using other techniques as well, such as Giclée printing, colour copying, screen printing, gravure, dye-sublimation, flexography, and the like.

The media of the present invention may have an excellent lightfastness, viz. dye stability during the display or storage in the presence of (ambient) light. Lightfastness may be quantified using known techniques, for example by using an Atlas Wether-O-Meter C I 35A, manufactured by Atlas (Illinois, U.S.A.) and exposing the image during 144 h using a xenon light at 85,000 lx.

The image density of the color on the printed area can be measured before and after the xenon exposure e.g. by a reflection densitometer (X-Rite 310TR). It can be expressed as the dye residual percentage. The media of the present invention may have a residual dye percentage (measured using a Wether-O-Meter C I 35A and the X-Rite 310TR under the conditions set out above) as high as 80% or more.

Furthermore, the media of the present invention may have an excellent coloration behavior, the coloration of the media upon storage at typical storage conditions being minimal. The coloration (viz. the “yellowing” of the white parts of the media of the present invention upon aging) may be assessed using a protocol in which L, a*, b* values are measured by a spectrophotometer (e.g. a MINOLTA CM-1000R). The media of the present invention may have a ΔE (whiteness difference, expressed as b* values measured on a spectrophotometer, before and after aging) value after two weeks of storage at 50° C. and 40% relative humidity of less than 5, preferably 2 or less.

The present invention will be illustrated in detail by the following non-limiting examples. Unless stated otherwise, all ratios given are based on weight.

### EXAMPLES

A. Preparation of Overlayer Solution-A of the Ink Receiving Layer.

A solution containing 50 weight parts of Gelita® Imagel MA (dodecenyl-succinic modified acid treated gelatin from Stoess GmbH, Germany with an IEP of 5.4 (modification grade 40%)), 1 weight part of Zonyl® FSN surfactant (a non-ionic fluoro-carbon type of surfactant), and 949 weight parts of water was prepared at 40° C. The pH of the solution was adjusted to 8.5 by adding NaOH.

B. Preparation of Gelatin Solution-B of the Ink Receiving Layer with an IEP of 9

A solution containing 50 weight parts of acid pigskin gelatin from Stoess GmbH, Germany with an IEP of 9 and 950 weight parts of water was prepared at 40° C. The pH of the solution was adjusted to 8.5 by adding NaOH.

C. Preparation of Gelatin Solution-C with an IEP of 7

A solution containing 50 weight parts of acid bone gelatin from PB Gelatins with an IEP of 7 and 950 weight parts of water was prepared at 40° C. The pH of the solution was adjusted to 8.5 by adding NaOH

D. Preparation of Gelatin Hydrophilic Polymer Solution-D with an IEP of 5.0.

A 20 wt. % solution of a lime bone gelatin with an IEP of 5.0 was prepared at pH 9. An aqueous solution of 10 wt % polyethylene oxide (PEO) having molecular weight of approximately 100,000 (from Sigma Aldrich chemicals, the Netherlands), was also prepared at pH 9. A homogeneous mixture, i.e. no phase separation, of gelatin and PEO having a weight ratio of 6:1 was made by adding 143 weight parts of said PEO solution and 429 weight parts of water into 428 weight parts of said gelatin solution at a temperature of 40° C. This mixture was agitated gently for about 30 minutes.

E. Preparation of Gelatin Hydrophilic Polymer Solution-E with an IEP of 5.0

Polymer solution-E was prepared in the same way as polymer solution-D. A mixture of gelatin and polyvinyl pyrollidone (PVP) was prepared in the weight ratio of 6 to 1 wherein PVP has a molecular weight of about 30 000 Daltons (ICN Biochemicals).

F. Coating of the Ink Receiving Layers.

Samples were coated according to the formulations shown in Table 1. The layers shown in Table 1 were fed into a slide coating machine, commonly known in the photographic industry, and coated on a photographic grade paper having polyethylene laminated at both sides. The flow of the under- and overlayers were adjusted such that, after drying, a total solid content of the underlayer(s) (=gelatin+other water soluble polymer) between 8 to 25 g/m² was obtained and a total solid content of the overlayer between 0.5 and 5 g/m². After coating, the coated material was chilled at a temperature of ca. 12° C. to set the gelatin and then dried with dry air at a maximum temperature of 40° C.

G. Schematic Drawing and Definition of the Layer Structure:

The ink receiving layer consists of at least three underlayers and one overlayer as shown in the scheme below.

Overlayer
Underlayer 3
Underlayer 2
Underlayer 1
Laminated Substrate

### EXAMPLES

| | #1 | #2 | #3 | #4 | #5 | #6 | #7 |
|---|---|---|---|---|---|---|---|
| Overlayer | A | A | A | A | A | A | A |
| Underlayer 3 | B | B | C | C | D | E | D |
| Underlayer 2 | C | C | D | C | D | E | E |
| Underlayer 1 | D | E | E | D | D | E | E |

H. Evaluation of the Printed Image on the Media

The ink-jet media prepared by the above mentioned formulation and said coating process, were printed with a standard image comprising black, cyan, magenta and yellow bars. The image contained also two pictures; including a portrait picture and a composition picture. The image was printed at a room conditions (23° C. and 48% Relative Humidity (RH)) and the printed materials were kept at this condition for at least 1 hour to dry.

A HP Deskjet® 995c was used to print the images by using the following settings:
Print quality: best
Selected Paper type: HP premium plus photo paper, glossy
Other parameters were according to the factory setting.

The quality of the printed images were further analysed visually by analysing the beading behaviour, the glossiness of especially the black area, the dryness of especially the black area, and the bleeding behaviour after some period of time.

I. Definitions of the Image Evaluation

1. Light Fastness

Light fastness is the dye stability during the display or storage at light condition. In order to evaluate this behaviour a sample was exposed for 144 hrs using a xenon light (85,000 lx) in an Atlas Wether-O-Meter C I 35A, (manufactured by Atlas (Illinois, U.S.A.)). The image density of the color on the printed area is measured before and after the xenon exposure and was measured by a reflection densitometer (X-Rite 310TR) and evaluated as the dye residual percentage. The following classification has been defined:

O: 80% or more residual percentage

Δ: 80-60% residual density

X: less than 60% of residual density

2. Beading Behaviour

As set out hereinabove, beading is defined as the phenomenon that large ink dots become visible on the printed image. The following classification has been defined:

O: no beading is observed

Δ: some small spots which is not very visible and/or beading that can be solved by selecting another printer setting.

X: Clearly visible

3. Glossiness after Printing.

The glossiness of the image directly after printing and after two days were analysed by observing the reflection of light on the high density area of the print (e.g. black colour). The more reflection was observed, the glossier the printed image. The following classification was defined for judging the glossiness:

O: Still glossy after 2 days without any defects

Δ: Gloss after printing, but after 2 days some ‘matte” spots are observed.

X: Matte appearance after printing, or a lot of “matte” spots after 2 days.

J. Results

| | #1 | #2 | #3 | #4 | #5 | #6 | #7 |
|---|---|---|---|---|---|---|---|
| Lightfastness | ◯ | ◯ | ◯ | ◯ | Δ | Δ | Δ |
| Beading | ◯ | ◯ | ◯ | ◯ | ◯ | ◯ | ◯ |
| Glossiness | ◯ | ◯ | ◯ | ◯ | ◯ | ◯ | ◯ |

With an IEP difference of 2 or more between the overlayer and (one of) the underlayers a very good lightfastness is obtained. Although in examples 5-7 the underlayer has a different IEP (i.e. 5.0) from the overlayer (IEP=5.4) the difference is rather small resulting in clearly less effect on lightfastness. The difference in IEP is preferably larger than 1, more preferably larger than 2.

1. A recording medium comprising a support and an ink-receiving layer adhered to said support, wherein the ink receiving layer is a multilayer comprising at least one overlayer and at least one underlayer, which underlayer is situated between said support and said overlayer, wherein said underlayer and said overlayer each comprise a gelatin and/or a modified gelatin, wherein the isoelectric point (IEP) of the gelatin or modified gelatin in the overlayer has a value that is different from the IEP value of the gelatin or modified gelatin of at least one of the underlayers.

2. The medium according to claim 1, wherein the IEP of the gelatin of at least one of said underlayers is from 6 to 11.

3. The medium according to claim 1, wherein the underlayer is a multi layer from which the IEP of the gelatin of the layer nearest to the overlayer is from 6 to 11.

4. The medium according to claim 1, wherein the difference in IEP between the (modified) gelatin in the overlayer and the (modified) gelatin in the underlayer is at least 1.

5. The medium according to claim 1, wherein the underlayer is a multi layer of which the IEP of the gelatin of the layer nearest to the overlayer is higher than the IEP of the gelatin nearest to the substrate.

6. The medium according to claim 1, wherein the gelatin with an IEP from 6 to 11 is chosen from acid treated bone, skin, pig or cow gelatin.

7. The medium according to claim 1, wherein said underlayer further comprises one or more water soluble polymers.

8. The medium according to claim 7, wherein the ratio of gelatin/water soluble polymer is lower in the layer nearest to the overlayer compared to said ratio in the layer(s) nearer to the support.

9. The medium according to claim 7, wherein said water soluble polymer is selected from polyvinyl alcohol (PVA) based polymers, cellulose derivatives, polyethylene oxide, polyacrylamide, polyvinylpyrollidone or mixtures thereof.

10. The medium according to claim 9, wherein said PVA-based polymer is selected from the group consisting of fully hydrolysed or partially hydrolysed polyvinyl alcohol, carboxylated PVA, acetoacetylated PVA, quaternary ammonium modified PVA, copolymers and terpolymers of PVA with other polymers such as a PVA-NVF polymer according to formula I: 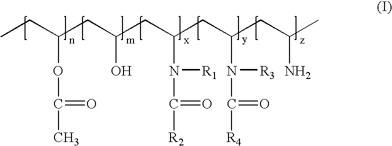
wherein
n is between 0 and about 20 mole percent;
m is between about 50 and about 97 mole percent;
x is between 0 and about 20 mole percent;
y is between 0 and about 20 mole percent;
z is between 0 and about 2 mole percent and
x+y is between about 3 and about 20 mole percent;
R₁, and R₃ are independently H, 3-propionic acid or C₁-C₆ alkyl ester thereof, or is 2-methyl-3-propionic acid or C₁-C₆ alkyl ester thereof; and
R₂ and R₄ are independently H or C₁-C₆ alkyl.

11. The medium according to claim 1, wherein the IEP of the gelatin in said overlayer is from 4 to 6.

12. The medium according to claim 1, wherein said overlayer comprises a modified gelatin which is selected from the group consisting of acetylated gelatin, phthalated gelatin, alkyl quaternary ammonium modified gelatin, succinated gelatin, alkylsuccinated gelatin, gelatin chemically modified with N-hydroxysuccinimide ester of fatty acid, and combinations thereof.

13. The ink-jet recording medium according to claim 1 in which the modified gelatin is used in an amount of 0.3 to 5.0 g/m².

14. The inkjet recording medium according to claim 1, in which the overlayer comprises further at least one fluoro-surfactant, preferably a fluoro-surfactant selected from the group of Li, K and Na—N-perfluoro C₄-C₁₃ alkane sulfonyl-N-alkyl glycine, 1,4-bis(fluoroalkyl)-2-[2-N,N,N-trialkylammonium)alkyl amino]butanedioate, and fluorosurfactants having the chemical structure of R_{f}CH₂CH₂SCH₂CH₂CO₂Li or R_{f}CH₂CH₂O(CH₂CH₂O)_{X}H wherein R_{f}=F(CF₂CF₂)₃₋₈.

15. The ink-jet according to claim 14, wherein the amount of fluoro-surfactant is from 2.5 to 250 mg/m².

16. The ink-jet recording medium according to claim 1 wherein the amount of said gelatin is from 1 to 30 g/m², preferably from 2 to 20 g/m² and the amount of said water soluble polymer is from 0.1 to 30 g/m², preferably from 0.2 to 20 g/m².

17. The medium according to claim 1, wherein the support is selected from a paper, a base paper, a pigment coated base paper, a laminated pigment coated base paper, a laminated paper, a synthetic paper or a film support.

18. The medium according to claim 1, wherein the support has a surface roughness Ra smaller than 1.0 μm.

19. A process for producing an ink-jet recording medium, comprising the steps of:
preparation of one or more homogeneous aqueous mixtures wherein at least one mixture comprises a gelatin or a modified gelatin for one or more underlayer(s);
preparation of at least one aqueous mixture comprising at least a (modified) gelatin with an IEP different from the IEP of the gelatin in one of the underlayers, for the overlayer; and
coating said mixtures consecutively or simultaneously on a support, followed by drying the coated support.

20. A method of forming a permanent, precise ink-jet image comprising the steps of:
providing an ink-jet recording medium as defined in claim 1; and
bringing ink-jet ink into contact with the medium in the pattern of a desired image.

21. The medium according to claim 1, wherein the difference in IEP between the (modified) gelatin in the overlayer and the (modified) gelatin in the underlayer is at least 2.

22. The ink-jet recording medium according to claim 1 in which the modified gelatin is used in an amount of from 0.5 to 3.0 g/m².

23. The medium according to claim 1, wherein the support has a surface roughness Ra smaller than 0.8 μm.
